(19) United States
(12) Patent Application Publication
(10) Pub. No.: US 2018/0371654 A1
(43) Pub. Date: Dec. 27, 2018

(54) THERMAL INSULATION FILLING MATERIAL AND PREPARATION METHOD THEREOF AND THERMAL INSULATION PRODUCT

(71) Applicant: 3M INNOVATIVE PROPERTIES COMPANY, St. Paul, MN (US)

(72) Inventors: Weili Hu, Shanghai (CN); Xiaoshuan Fu, Shanghai (CN); Guo Tong Zhao, Shanghai (CN)

(73) Assignee: 3M INNOVATIVE PROPERTIES COMPANY, St Paul, MN (US)

(21) Appl. No.: 16/064,134

(22) PCT Filed: Dec. 22, 2016
(86) PCT No.: PCT/US16/68283

§ 371 Date: Jun. 20, 2018

(30) Foreign Application Priority Data
Dec. 30, 2015 (CN) 201511023721.5

(51) Int. Cl. D04H 1/413; B32B 5/08; B32B 5/24; B32B 27/12; B32B 27/36; B32B 5/02; D04H 1/732; D04H 1/54; A43B 7/00; A42B 1/00; A41D 31/02; D04H 1/435; B68G 3/00; B68G 1/00

(52) U.S. Cl. CPC D04H 1/413; A47G 9/0223; B32B 5/245; B32B 27/12; B32B 27/36; B32B 5/022; D04H 1/732; D04H 1/54; A43B 7/00; A42B 1/008; A41D 31/02; D04H 1/435; B68G 3/00; B68G 1/00; B32B 2307/304; B32B 2255/02; B32B 2255/26; B32B 2262/0276; B32B 2437/00; A41D 2400/10; A41D 2500/30; D10B 2501/042; D10B 2501/043; D10B 2503/06; D10B 2505/08; D10B 2331/04; B32B 5/08

(57) ABSTRACT

The present invention provides a thermal insulation filling material and preparation method thereof and a thermal insulation product, and pertains to the field of thermal insulation filling materials. The thermal insulation filling material of the present invention includes: a bulk fibre; and a spherical fibre assembly, where a water-repellent layer is formed on a surface of the bulk fibre and of the spherical fibre assembly, and a weight ratio of the bulk fibre to the spherical fibre assembly is between about 30:70 and about 70:30. The thermal insulation filling material is good in wash durability, and has comprehensive performance such as better blowable processability, quick-drying property, compression-resilience property, and thermal insulation property, etc. The method for preparing the thermal insulation filling material includes: adding a water-repellent agent in the process of gas-flow mixing the bulk fibre and the spherical fibre assembly, and then heating to form a water-repellent layer on the surface of the bulk fibre and of the spherical fibre assembly.

### FIELD OF THE INVENTION

The present invention pertains to the field of thermal insulation filling materials, and specifically relates to a thermal insulation filling material and preparation method thereof and a thermal insulation product.

### BACKGROUND ART

Generally, thermal insulation materials are filled in clothes and bedclothes or the like to improve the thermal insulation property thereof. Generally, thermal insulation filling material is a bulk material including fine fibres. These fibres may mutually shift when they are under stress, so that the overall shape of a product may vary as a user flaps or presses, thereby better fitting in with the user's body and improving the use experience.

Conventional thermal insulation filling material mainly is natural down such as duck down, goose down, etc. The physical structure of natural down endows it with good filling power, compression-resilience property and thermal insulation property, etc. However, natural down is not stable in source, and thus is limited in yield, high in cost, and uneven in quality. In addition, natural down is generally poor in durability, is prone to mildewing and causing an anaphylactic reaction. For these reasons, the application scope of natural down is limited.

Therefore, people have been seeking artificial thermal insulation filling material that can replace natural down. Some fibre companies at home and abroad have successively launched down-like polyester staple fibre series as new-type filling materials. The prior art includes using different-sized polyester staple fibres and mixed materials thereof, for example, U.S. Pat. No. 4,588,635 and U.S. Pat. No. 6,329,051; down and feather or mixed materials of other natural fibres and polyester staple fibres, for example, US20140206796 and U.S. Pat. No. 6,329,052; mixed materials of crimped polyester staple fibres and low-melting-point fibres, for example, U.S. Pat. No. 4,992,327. However, thermal insulation filling materials obtained by means of these prior arts are poor in thermal insulation property, filling power, compression-resilience property, wash durability, and blowable processability (i.e., processability by means of blowing), etc.

### SUMMARY OF THE INVENTION

According to one aspect, the present invention provides a thermal insulation filling material, which is good in wash durability, and has combination properties such as better blowable processability, quick-drying property, compression-resilience property, and thermal insulation property, etc.

The thermal insulation filling material of the present invention includes:

a bulk fibre; and

a spherical fibre assembly;

wherein

a water-repellent layer is formed on a surface of the bulk fibre and of the spherical fibre assembly, and

a weight ratio of the bulk fibre to the spherical fibre assembly is between about 30:70 and about 70:30.

According to another aspect, the present invention provides a method for preparing thermal insulation filling material, in which, the foregoing thermal insulation filling material can be obtained by means of simple processes.

The method for preparing thermal insulation filling material includes:

gas-flow mixing a bulk fibre and a spherical fibre assembly to form a mixture, and adding a water-repellent agent in the mixing process, wherein a weight ratio of the bulk fibre to the spherical fibre assembly is between about 30:70 and about 70:30; and

heating to form a water-repellent layer on the surface of the bulk fibre and of the spherical fibre assembly.

According to another aspect, the present invention provides a thermal insulation product filled with the foregoing thermal insulation filling material. The thermal insulation product may be filled by means of blowing, is convenient for processing, and has combination properties such as excellent wash durability, quick-drying property, compression-resilience property, and thermal insulation property, etc.

The thermal insulation product includes:

a cladding body, configured to define enclosed internal space; and

thermal insulation filling material filled in enclosed internal space as defined by the cladding body, wherein the thermal insulation filling material comprises: a bulk fibre; and a spherical fibre assembly, wherein a water-repellent layer is formed on a surface of the bulk fibre and of the spherical fibre assembly, and a weight ratio of the bulk fibre to the spherical fibre assembly is between about 30:70 and about 70:30.

### BRIEF DESCRIPTION OF THE DRAWINGS

FIG. 1 is a photo of thermal insulation filling material in Embodiment 1 of the present invention;

FIG. 2 is a comparison chart of test results of thermal insulation property of thermal insulation filling materials in embodiments of the present invention and a comparative example;

FIG. 3 is a photo of the washed thermal insulation filling material in Embodiment 1 of the present invention;

FIG. 4 is an infrared image of a washed sample package 2 filling the thermal insulation filling material in Embodiment 1 of the present invention;

FIG. 5 is a photo of the washed thermal insulation filling material in a comparative example 1 of the present invention;

FIG. 6 is an infrared image of a washed sample package 2 filling the thermal insulation filling material in the comparative example 1 of the present invention;

FIG. 7 is a photo of the washed thermal insulation filling material in a comparative example 3 of the present invention;

FIG. 8 is an infrared image of a washed sample package 2 filling the thermal insulation filling material in the comparative example 3 of the present invention; and

FIG. 9 is a comparison chart of test results of thermal resistance retention rate of the thermal insulation filling materials in embodiments and comparative examples.

### DETAILED DESCRIPTION OF THE EMBODIMENTS

In order for those skilled in the art to better understand the technical solution of the present invention, the following further describes in detail the present invention with reference to the accompanying drawings and embodiments.

Phraseology Interpretation

In the present invention, meanings of the following terms or descriptive approaches are as below:

Description of “between A and B” or “from A to B” includes a value of A, a value of B, and any value that is greater than A and smaller than B. For example, “between 1 and 10” includes, 1, 10 and any value that is greater than 1 and smaller than 10, for example, 2, 3, 4, 5, 6, 7, 8, 9, 2.3, 3.516, 5.26, 7.1 and 9.999, etc.

Description of “A is essentially equal to B” or “A is approximate to B” or “A is substantially equal to B” means that A conforms to B on the whole, allowing unavoidable small difference between A and B, and the difference being minor with respect to the dimension of B.

“Material dosage”: in the present invention, material dosage or dosage ratio refers to weight or weight ratio unless specifically stated.

“Weight percentage of A in B” refers to percentage of A in B when A belongs to a part of B and weight of B is denoted by 100%.

“Weight ratio of A to B” refers to proportional relationship between weight of A and weight of B when A is different from other constituents of B.

“Fibre” refers to a continuous or discontinuous filament, the dimension of which in the length direction is far greater than that thereof in any direction in a cross section.

“Bulk fibre” refers to material consisting of a large number of fine, fluffy and irregular fibres, also referred to as “loose fibre”.

“Spherical fibre assembly” refers to material consisting of a great number of “fibre balls”, and fibre balls are basically spherical materials formed by winding fibres.

“Denier (D)” is a unit of fibre fineness, representing weight in grams of a 9,000-meter-long fibre at the conventional moisture regain.

“Clo value” is a parameter for evaluating the thermal insulation property of a material, which in essence is a thermal resistance value, the larger the value is, the better the thermal insulation property is. When a person sits quietly or engages in mild mental labor (with a calorific power of 209.2 kJ/m²·h) at 21° C. in a relative humidity smaller than 50% at an air speed not more than 0.1 m/s and feels comfortable, the Clo value for the clothes which the person wears is defined as 1.

### Thermal Insulation Filling Material

An embodiment of the present invention provides a thermal insulation filling material, which includes:

a bulk fibre; and

a spherical fibre assembly;

where

a water-repellent layer is formed on the surface of the bulk fibre and of the spherical fibre assembly, and

a weight ratio of the bulk fibre to the spherical fibre assembly is between about 30:70 and about 70:30.

The thermal insulation filling material of the embodiments of the present invention includes a bulk fibre and a spherical fibre assembly in a specific proportion, and a water-repellent layer is formed on the surface of the bulk fibre and of the spherical fibre assembly.

The water-repellent layer is a layer formed by a dried water-repellent agent, which is generally used to make a fabric surface have water repellency. However, in the embodiments of the present invention, the water-repellent layer is used on the surface of fibrous material. The water-repellent agent available in the embodiments of the present invention includes but is not limited to: any one or more of organofluorine water-repellent agents, organosilicone water-repellent agents, fluosilicic combination water-repellent agents, and hydrocarbon water-repellent agents.

In the present invention, it is creatively found that by mixing the bulk fibre and the spherical fibre assembly in a specific proportion and by forming a water-repellent layer on the surface thereof, the thermal insulation filling material obtained has excellent wash durability, and also has comprehensive performance such as better blowable processability, quick-drying property, compression-resilience property, and thermal insulation property, etc.

Preferably, the weight ratio of the bulk fibre to the spherical fibre assembly is between about 40:60 and about 60:40, more preferably between about 45:55 and about 55:45, and further preferably about 50:50.

In other words, in the bulk fibre and the spherical fibre assembly, the weight percentage of the bulk fibre is between 30% and 70%, preferably between 40% and 60%, more preferably between 45% and 55%, and the most preferably 50%. Correspondingly, the weight percentage of the spherical fibre assembly is between 30% and 70%, preferably between 40% and 60%, more preferably between 45% and 55%, and the most preferably 50%.

Preferably, the fibre constituting the bulk fibre has a length between about 15 mm and about 75 mm, and more preferably has a length between about 28 mm and about 51 mm.

Preferably, the fibre constituting the bulk fibre has a fineness between about 0.2 D and about 15 D, and more preferably has a fineness between about 0.5 D and about 7 D.

In other words, the fibre constituting the foregoing bulk fibre preferably has a length between 15 mm and 75 mm and a fineness between 0.2 D and 15 D, and more preferably has a length between 28 mm and 51 mm and a fineness between 0.5 D and 7 D.

Specifically, the fibre constituting the bulk fibre may have a crimp structure or a non-crimp structure.

Preferably, the fibre constituting the spherical fibre assembly has a length between about 15 mm and about 75 mm, and more preferably has a length between about 28 mm and about 64 mm.

Preferably, the fibre constituting the spherical fibre assembly has a fineness between about 0.7 D and about 15 D, and more preferably has a fineness between about 3D and about 7 D.

In other words, the fibre constituting the foregoing spherical fibre assembly preferably has a length between 15 mm and 75 mm and a fineness between 0.7 D and 15 D, and more preferably has a length between 28 mm and 64 mm and a fineness between 3D and 7 D.

Preferably, the fibre constituting the spherical fibre assembly has a three-dimensional crimp hollow structure.

In other words, the fibre for forming the foregoing spherical fibre assembly preferably has a three-dimensional crimp hollow structure, thereby facilitating forming a fibre ball.

Preferably, the spherical fibre assembly has a particle size ranged between about 3 mm and about 15 mm.

In other words, in the spherical fibre assembly, the particle size of each fibre ball is preferably between 3 mm and 15 mm. It should be understood that in the spherical fibre assembly of the same thermal insulation filling material, different fibre balls may have different particle sizes, as long as they are within the foregoing range.

In terms of chemical constituent, fibres in the foregoing bulk fibre and the spherical fibre assembly include but are not limited to one or more of polyester fibre, polyamide fibre, polyvinyl chloride fibre, acrylic fibre and polypropylene fibre. However, as a preferred manner, the foregoing fibres are silicone fibres. For example, specifically available silicone fibres include silicone polyester fibres, etc.

It should be understood that in the same thermal insulation filling material, the fibre constituting the bulk fibre and the fibre constituting the spherical fibre assembly may be the same kind of fibre or different fibres (for example, different chemical constituents, lengths, finenesses and degrees of crimp or the like). Furthermore, the bulk fibre (or the spherical fibre assembly) itself may consist of the same kind of fibre or multiple different fibres.

It should be understood that although it is described hereinabove the bulk fibre and the spherical fibre assembly necessarily included in the thermal insulation filling material, it is also practicable if the thermal insulation filling material further includes other known constituents or additives, etc.

### Method for Preparing Thermal Insulation Filling Material

An embodiment of the present invention provides a method for preparing thermal insulation filling material, which includes:

gas-flow mixing a bulk fibre and a spherical fibre assembly to form a mixture, and adding a water-repellent agent in the mixing process, where the weight ratio of the bulk fibre to the spherical fibre assembly is between about 30:70 and about 70:30; and

heating to form a water-repellent layer on the surface of the bulk fibre and of the spherical fibre assembly.

In the method for preparing thermal insulation filling material of the embodiments of the present invention, gasflow is used to mix the bulk fibre and the spherical fibre assembly, and the water-repellent agent is introduced simultaneously. In this way, the water repellency treatment process and the mixing process are combined as one, and the preparation process is simplified. Furthermore, in the mixing process, materials are fully stirred to ensure a mixing uniformity. Thus, the water-repellent agent added in the mixing process naturally uniformly dispersed on the surface of the fibrous material, thereby forming a uniform and complete layer of a water-repellent agent, and ensuring a good effect of water repellency treatment.

Preferably, the ratio of the weight of the water-repellent agent to the total weight of the bulk fibre and the spherical fibre assembly is between about 0.5% and about 5%, and more preferably between about 1% and about 2.5%.

Usage amount of the water-repellent agent is apparently related to the performance of a final product. In the embodiments of the present invention, it is discovered that when the total weight of fibres (the bulk fibre and the spherical fibre assembly) is 100%, the relative weight of the water-repellent agent is from 0.5% to 5%, and more preferably from 1% to 2.5%.

Preferably, the temperature of the heating is between about 110° C. and about 200° C.; and time of the heating is between about 2 minutes and about 10 minutes.

The heating treatment is in order to dry the water-repellent agent, thereby forming a water-repellent layer on the surface of the fibrous material. Generally it is heated for 2 minutes to 10 minutes at 110° C. to 200° C.

Thermal Insulation Product

An embodiment of the present invention provides a thermal insulation product filled with the foregoing thermal insulation filling material, which includes:

a cladding body, configured to define enclosed internal space; and

thermal insulation filling material filled in enclosed internal space as defined by the cladding body, where the thermal insulation filling material includes: a bulk fibre; and a spherical fibre assembly; a water-repellent layer is formed on the surface of the bulk fibre and of the spherical fibre assembly, and the weight ratio of the bulk fibre to the spherical fibre assembly is between about 30:70 and about 70:30.

In other words, the foregoing thermal insulation filling material may be filled in an enclosed cladding structure, thereby forming a thermal insulation product that can be practically used.

Preferably, the cladding body is a flexible cladding body.

In other words, the foregoing cladding body may be flexible material such as shell fabric or leather or the like, and thus can form enclosed internal space by means of sewing technology or the like. Therefore, the thermal insulation product is also flexible, and may deform to a certain extent as a user needs, thereby providing the user with more comfortable use experience.

Preferably, the foregoing thermal insulation product may be bedclothes, clothes or the like, a specific example thereof includes but is not limited to: shoes, a cap, clothes (including a coat, trousers, underclothes, overclothes or the like), a pillow, a quilt, a mattress, a sleeping bag, etc.

### EMBODIMENTS

The following provides a more detailed description of the embodiments of the present invention.

### 1. Raw Materials

In the embodiments of the present invention, raw materials used are as below:

Fibrous raw material 1: three-dimensional hollow silicone polyester fibre, having a length of 64 mm and a fineness of 3D, purchased from Sinopec Yizheng Chemical Fibre Company Limited (YCF).

Fibrous raw material 2: three-dimensional hollow silicone polyester fibre, having a length of 64 mm and a fineness of 3D, purchased from Far Eastern Industries (shanghai) Co., Ltd.

Water-repellent agent 1: Scotchgard PM-3633, purchased from 3M China Limited.

Water-repellent agent 2: OLEOPHOBOL CP-SLA, purchased from Huntsman Corporation.

### 2. Performance Test Methods

In order to evaluate the performance of thermal insulation filling materials in various embodiments and comparative examples, it is necessary to conduct a series of performance tests, and specific test methods are as below:

1) Sample Package Preparation

Sewing 90 g of sample into a 12 inch×12 inch nylon cloth package, and serving as a sample package 1.

Blowing the sample to a 50 cm×50 cm nylon cloth package according to a filling amount of 200 g/m² (gsm), and sewing five 10 cm×50 cm rectangular quilted lattice, and thus obtaining a sample package 2.

2) Blowable Processability

Conducting a down filling test on various samples by using a Bealead 126B down filling machine to watch whether a successful down filling is available to samples.

3) Filling Power

Selecting 28.4 g of dried sample and dispersing small clusters having a diameter of about 2.5 cm, then filling into an organic glass cylinder having volume scale (with a diameter of about 24.5 cm and a height greater than 50 cm); placing a pressure plate (having a weight of about 68.4 g and a diameter of about 24 cm) slightly in the organic glass cylinder, and start timing when the pressure plate touches samples, after 30 s recording the scale value (with a unit of cubic inch) of the organic glass cylinder corresponding to an edge of the pressure plate, measuring thrice and taking an average value, thereby obtaining a value of filling power of the sample.

4) Compression-Resilience Property

The compression-resilience property of the sample is tested according to Standard ASTM D6571-01(2001), specifically including:

Placing the sample package 1 on the base plate of a thickness gauge, applying a weight of 0.41 lb to the center of the pressure plate according to requirements for the foregoing Standard, recording the initial thickness A of the sample package 1; continuing applying an additional weight up to 16 lb according to the foregoing Standard and placing for 24 h; then relieving the additional weight to 0.41 lb, and recording the recovered thickness value C of the sample package 1 after waiting for 1 h; then calculating a short-term compression resilience ratio (%): 100%×C/A.

5) Thermal Insulation Property

Testing the thickness of the sample package 2 thrice at a pressure of 20 Pa, and taking the average value thereof as the thickness value.

A Clo value is tested in accordance with Standard ASTM F1868 Part C (i.e., Standard GB/T 11048), specifically including:

Spreading the sample package 2 on a test board having an area of A, then heating the test board with a heating power H; after the temperature becomes stable, recording the surface temperature Tm of the test board and the ambient temperature (air temperature) Ta; and calculating a thermal resistance R, R=[A×(Tm−Ta)/(H−ΔH)]−R₀, where ΔH is a predetermined heating power correction, and R₀ is a predetermined thermal resistance correction; and correspondingly, obtaining a Clo value=6.451R.

6) Water Repellency

A water repellency test is conducted according to Standard GB/T 24120-2009, specifically including:

placing a sample of a certain thickness on a transparent glass plate, and respectively dropping a drop of ethanol solution (the content of ethanol in ethanol solution having an n^{th} grade is n×10%) in five different positions of the sample; after certain time, comparing the permeation and diffusion of the liquid droplet with a standard condition, and judging it whether or not passes the test, testing again with ethanol solution having a higher grade if it passes the test, the highest grade of the ethanol solution by using which the sample can pass the test is the water repellency grade, and the higher the water repellency grade, the better the water repellency is.

7) Quick-Drying Property

After the sample package 2 is washed according to Standard ISO6330 7A, drying it in an environment having a temperature of 20±1° C. and a relative humidity of 30±2%, recording the weight of the sample package 2 every ten minutes until it reaches a constant weight, and taking the time when the constant weight is achieved as the drying time.

Washing is conducted by a FOM71 CLS type horizontal drum washing machine (purchased from Electrolux Corporation), where in various steps it is stirred evenly and gently; concrete procedures of washing each time include: washing for 3 minutes at a water temperature of 40±3° C. and a water level of 13 cm without cooling down, where 20 g standard detergent powder as stipulated in GB/T8629-2001:7A is used; rinsing for the first time for 3 minutes at a water level of 13 cm; rinsing for the second time for 3 minutes at a water level of 13 cm, the dewatering time being 1 minute; rinsing for the third time for 2 minutes at a water level of 13 cm, the dewatering time being 6 minutes.

8) Wash Durability

Washing the sample package 2 ten times according to Standard ISO6330 7A, where washing is conducted by a FOM71 CLS type horizontal drum washing machine (purchased from Electrolux Corporation), in various steps it is stirred evenly and gently; concrete procedures of washing each time include: washing for 3 minutes at a water temperature of 40±3° C. and a water level of 13 cm without cooling down, where 20 g standard detergent powder as stipulated in GB/T8629-2001:7A is used; rinsing for the first time for 3 minutes at a water level of 13 cm; rinsing for the second time for 3 minutes at a water level of 13 cm, the dewatering time being 1 minute; rinsing for the third time for 2 minutes at a water level of 13 cm, the dewatering time being 6 minutes; and then drying the sample package 2 by using a tumble dryer. Watching the infrared image of the sample package 2, and opening the sample package 2 to watch the appearance of the thermal insulation filling material therein.

Conducting a thermal resistance test (i.e., a Clo value test) on the sample package 2 washed, and calculating a thermal resistance retention rate (%)=100×(the Clo value after washing)/(the Clo value before washing).

### 3. Embodiments and Comparative Example

Different thermal insulation filling materials are prepared by using the foregoing raw materials for use in various embodiments and comparative examples, specifically as follows:

### Embodiment 1

Selecting 5 kg of the fibrous raw material 1 and forming a bulk fibre by means of opening and carding by using a YYSL type carding machine (purchased from Jiangsu Yingyang Nonwoven Machinery Co., Ltd.).

Selecting 5 kg of the fibrous raw material 1 and forming fibre balls having a particle size from 3 mm to 15 mm by using a ball forming mill (a HJZZM-100 type ball fibre machine purchased from Kunshan City, Hai Jin Machinery Co., Ltd.), serving as spherical fibre assemblies.

Feeding the two materials into an air-laid feeder (purchased from American Rando Corporation) at a spiked apron rate of 15 HZ to fully mix; simultaneously spraying the water-repellent agent 1 on the materials being mixed by means of a spraying device of the air-laid feeder, the nozzle pressure being 0.6 MPa, and a total weight of 200 g of the water-repellent agent 1 being used (i.e., the ratio of the weight of the water-repellent agent to the total weight of the bulk fibre and the spherical fibre assembly is 2%).

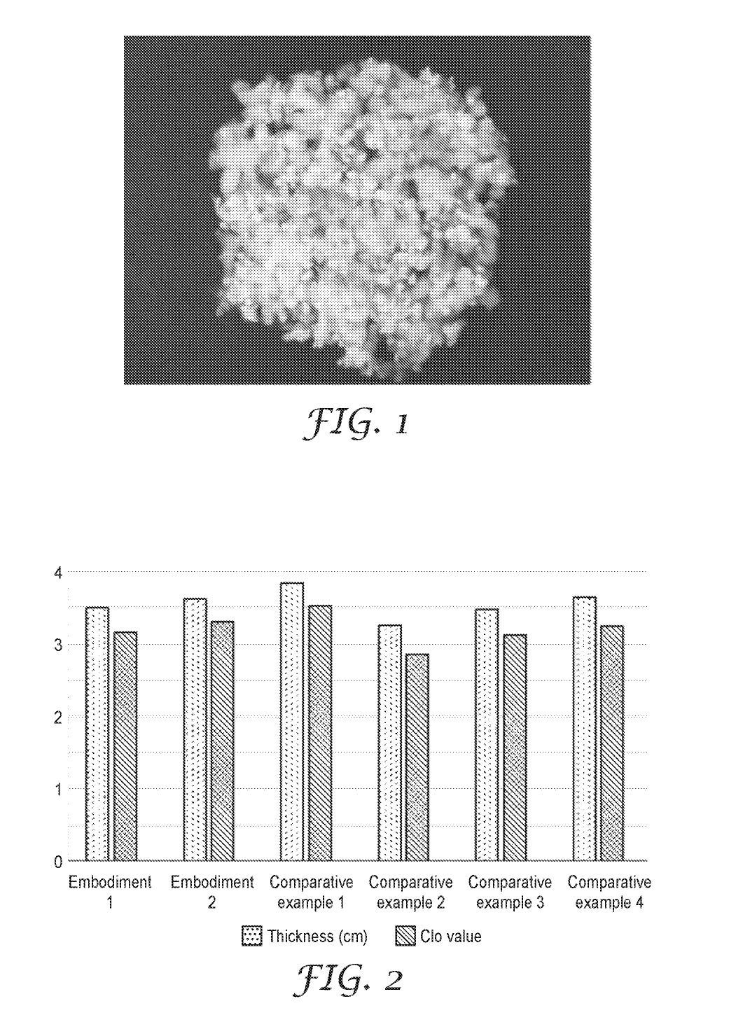

Pneumatically conveying the material mixed into a dryer and drying for 6 minutes to 9 minutes at 120° C., thereby preparing the thermal insulation filling material in Embodiment 1 as shown in FIG. 1.

### Embodiment 2

Selecting 7 kg of the fibrous raw material 2 and forming a bulk fibre by means of opening by using a HJKM-PP type opening machine (purchased from Kunshan City, Hai Jin Machinery Co., Ltd.).

Selecting 3 kg of the fibrous raw material 2 and forming fibre balls having a particle size from 3 mm to 15 mm by using a ball forming mill (a HJZZM-100 type ball fibre machine purchased from Kunshan City, Hai Jin Machinery Co., Ltd.), serving as spherical fibre assemblies.

Feeding the two materials into a Brad air-laid machine (described in US Patents US2005/0098910, US2010/0092746 and U.S. Pat. No. 7,491,354, and a PCT patent WO2011/133396A) to fully mix, where the rotating speed of a rotary roller is 180 r/min, and the running speed of a belt screen is 3 m/min; simultaneously spraying the water-repellent agent 2 on the materials being mixed by means of a spraying device at the side of the device, the nozzle pressure being 0.6 MPa, and a total weight of the water-repellent agent 2 used being 300 g (i.e., the ratio of the weight of the water-repellent agent to the total weight of the bulk fibre and the spherical fibre assembly is 3%).

Pneumatically conveying the material mixed into a dryer and drying for 5 minutes to 8 minutes at 150° C., thereby preparing the thermal insulation filling material in Embodiment 2.

### Comparative Embodiment 1

Selecting the foregoing fibrous raw material 1, and forming a bulk fibre (i.e., the thermal insulation filling material in comparative example 1) by means of opening and carding by using the carding machine.

### Comparative Embodiment 2

Selecting the fibrous raw material 1 and forming fibre balls having a particle size from 3 mm to 15 mm by using the foregoing ball forming mill, serving as separate spherical fibre assemblies, i.e., the thermal insulation filling material in comparative example 2.

### Comparative Embodiment 3

Selecting 5 kg of the fibrous raw material 1 and forming a bulk fibre by means of opening and carding by using the foregoing carding machine.

Selecting 5 kg of the fibrous raw material 1 and forming fibre balls having a particle size from 3 mm to 15 mm by using the foregoing ball forming mill, serving as spherical fibre assemblies.

Feeding the two materials into the foregoing air-laid feeder at a spiked apron rate of 15 HZ to fully mix, thereby preparing the thermal insulation filling material in Embodiment 3.

### Comparative Embodiment 4

Selecting 7 kg of the fibrous raw material 2 and forming a bulk fibre by means of opening by using the foregoing carding machine.

Selecting 3 kg of the fibrous raw material 2 and forming fibre balls having a particle size from 3 mm to 15 mm by using the foregoing ball forming mill, serving as spherical fibre assemblies.

Feeding the two materials into the foregoing Brad air-laid machine to fully mix, thereby preparing the thermal insulation filling material in comparative example 4.

### 4. Performance Test Results

Performance tests of the thermal insulation filling materials in various embodiments and comparative examples are conducted according to the foregoing performance test methods, and specific test results are as below:

1) Appearance

The appearance of the thermal insulation filling material in Embodiment 1 of the present invention is as shown in FIG. 1, from which it is clear that the fibres are fluffy and uniformly distributed, and have neither agglomeration nor intertwist, etc.

2) Blowable Processability

Down is filled in various thermal insulation filling materials according to the foregoing methods.

The down filling mouth is blocked by the thermal insulation filling material (purely bulk fibres) in comparative example 1 because of intertwist among fibres. However, down is successfully filled in thermal insulation filling materials in other embodiments and comparative examples. This indicates that the thermal insulation filling material of the present invention has good blowable processability, and can be filled by means of down blowing, thereby facilitating practically processing and using.

3) Filling Power

Values of filling power of various thermal insulation filling materials are measured by using the foregoing methods, and the results are as below:

TABLE 1
Values of filling power of thermal insulation filling materials
in various embodiments and comparative examples

| Sample | Value of filling power (cubic inch/ounce) |
|---|---|
| Embodiment 1 | 450 |
| Embodiment 2 | 520 |
| Comparative Embodiment 1 | 620 |
| Comparative Embodiment 2 | 300 |
| Comparative Embodiment 3 | 450 |
| Comparative Embodiment 4 | 520 |

It is clear that the thermal insulation filling materials in Embodiment 1 and Embodiment 2 of the present invention fall in between the thermal insulation filling material (purely bulk fibres) in comparative example 1 and the thermal insulation filling material (purely spherical fibre assemblies) in comparative example 2 in terms of filling power, and are respectively equivalent to the thermal insulation filling materials in comparative example 3 and comparative example 4. This indicates that by mixing the spherical fibre assembly and the bulk fibre, a filling power falling in between that of the two raw materials can be obtained, and water repellency treatment does not have a negative impact on filling power.

4) Compression-Resilience Property

Various thermal insulation filling materials are made into a sample package 1 according to the above methods, and the compression-resilience property thereof is tested, the test results are as below:

TABLE 2
Short-term compression resilience ratio of thermal insulation filling
materials in various embodiments and comparative examples

| Sample | Short-term compression resilience ratio (%) |
|---|---|
| Embodiment 1 | 78.2 |
| Embodiment 2 | 74.3 |
| Comparative Embodiment 1 | 65.8 |
| Comparative Embodiment 2 | 82.3 |
| Comparative Embodiment 3 | 78.0 |
| Comparative Embodiment 4 | 73.9 |

It is clear that the thermal insulation filling materials in Embodiment 1 and Embodiment 2 of the present invention fall in between the thermal insulation filling material (purely bulk fibres) in comparative example 1 and the thermal insulation filling material (purely spherical fibre assemblies) in comparative example 2 in terms of compression resilience ratio, and are respectively equivalent to the thermal insulation filling materials in comparative example 3 and comparative example 4. This indicates that by mixing the spherical fibre assembly and the bulk fibre, a compression resilience ratio falling in between that of the two raw materials can be obtained, and water repellency treatment does not have a negative impact on the compression resilience ratio.

5) Thermal Insulation Property

Various thermal insulation filling materials are made into a sample package 2 according to the above methods, and the thermal insulation property thereof is tested, the test results are as shown in FIG. 2.

It is clear that the thermal insulation filling materials in Embodiment 1 and Embodiment 2 of the present invention fall in between the thermal insulation filling material (purely bulk fibres) in comparative example 1 and the thermal insulation filling material (purely spherical fibre assemblies) in comparative example 2 in terms of thermal insulation property (thickness and a Clo value), and are respectively equivalent to the thermal insulation filling materials in comparative example 3 and comparative example 4. This indicates that by mixing the spherical fibre assembly and the bulk fibre, a thermal insulation property falling in between that of the two raw materials can be obtained, and water repellency treatment does not have a negative impact on the thermal insulation property.

6) Water Repellency

Water repellency of various thermal insulation filling materials are tested by using the foregoing methods, and the test results are as below:

TABLE 3
Water repellency of thermal insulation filling materials
in various embodiments and comparative examples

| Sample | Water repellency grade |
|---|---|
| Embodiment 1 | 6 |
| Embodiment 2 | 6 |
| Comparative Embodiment 1 | 3 |
| Comparative Embodiment 2 | 3 |
| Comparative Embodiment 3 | 3 |
| Comparative Embodiment 4 | 3 |

It is clear that water repellency grades of the thermal insulation filling materials of embodiments of the present invention are both Grade VI, much higher than the water repellency grades (Grade III) of the thermal insulation filling materials of various comparative examples. This indicates that good water repellency is obtained for the thermal insulation filling materials of the embodiments of the present invention by means of water repellency treatment.

7) Quick-Drying Property

Various thermal insulation filling materials are made into a sample package 2 according to the above methods, and the quick-drying property thereof is tested according to the above methods. The results show that the drying time of the thermal insulation filling material of Embodiment 1 is 30 minutes, and the drying time of the thermal insulation filling material of comparative example 3 is more than 80 minutes. It is thus clear that the thermal insulation filling material of the embodiments of the present invention has good quick-drying property.

8) Wash Durability

Various thermal insulation filling materials are made into a sample package 2 according to the above methods, and the sample package 2 is washed ten times according to the above methods.

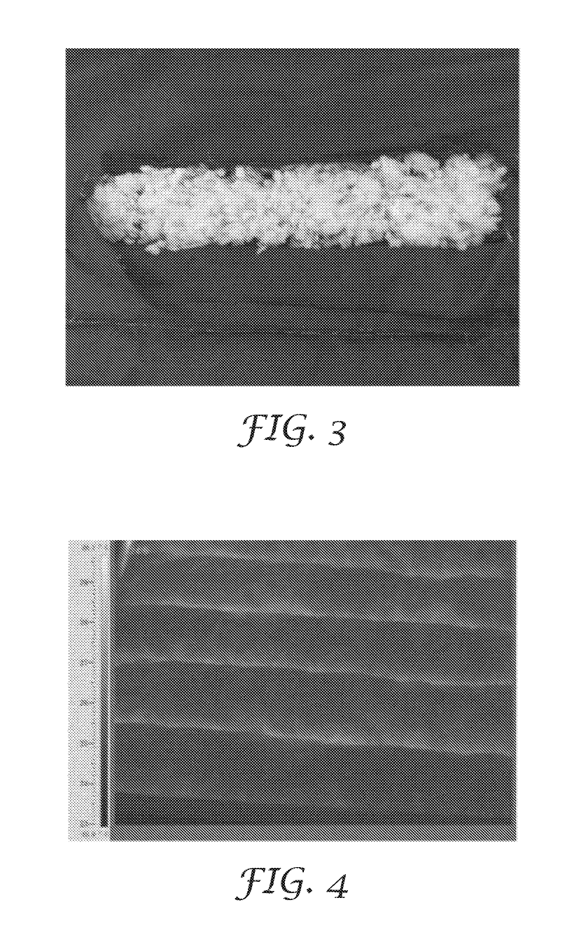

As shown in FIG. 3 and FIG. 4, the appearance of various thermal insulation filling materials of Embodiment 1 is basically unchanged, still fluffy and uniform, and the infra-red photo thereof has no phenomenon of uneven light and shade. This indicates that the thermal insulation filling material of the embodiments of the present invention does not change in shape apparently after it is washed, and remains basically the same as before it is washed.

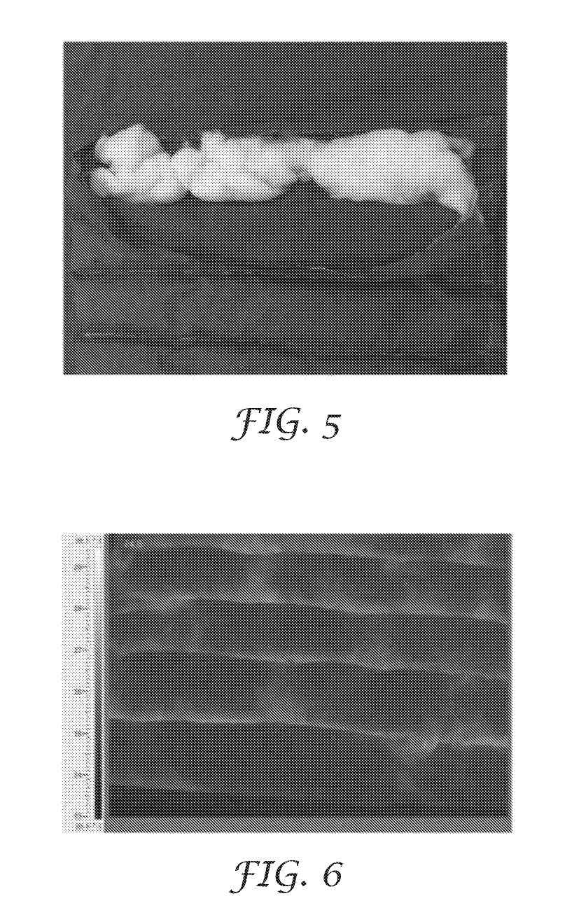

As shown in FIG. 5 and FIG. 6, after being washed, the thermal insulation filling material (purely bulk fibres) of comparative example 1 obviously forms patchy shadows, and the infra-red photo thereof has apparent uneven light and shade. This indicates that serious intertwist occurs in the thermal insulation filling material of comparative example 1 after it is washed, so that a lot of faultage where there is no thermal insulation filling material is formed in the sample package 2, which is difficult to be flapped uniformly, thereby having a negative effect on the appearance, the thermal insulation property and comfort or the like of a product.

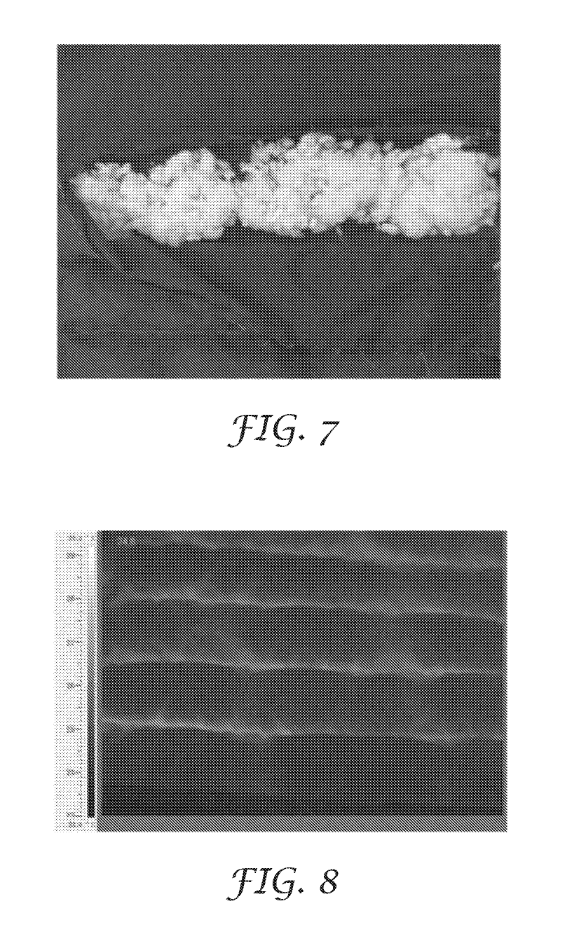

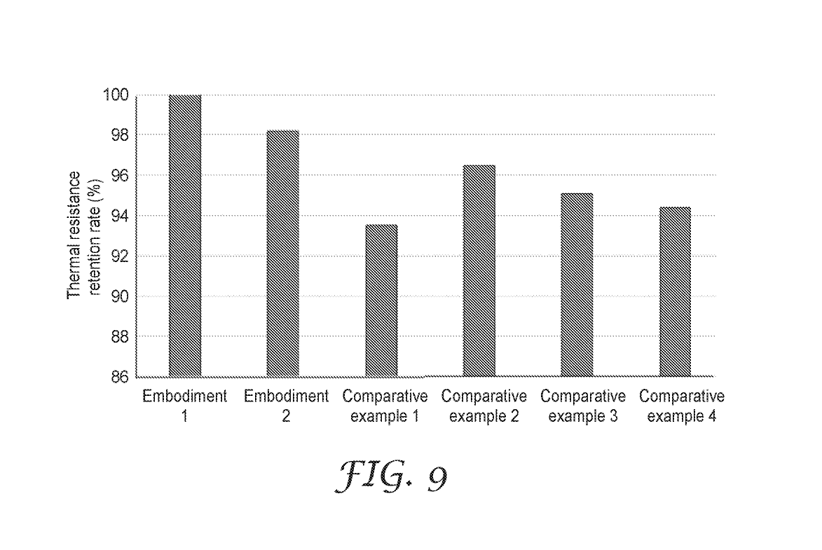

As shown in FIG. 7 and FIG. 8, after being washed, the thermal insulation filling material of comparative example 3 also has the phenomenon of agglomeration and unevenness, and the infra-red photo thereof also has uneven light and shade, merely being not as much as the thermal insulation filling material of comparative example 1.

The thermal resistance retention rate of various thermal insulation filling materials washed is as shown in FIG. 9. It is clear that thermal resistance retention rate of the thermal insulation filling material of the embodiments of the present invention is above 98%, apparently higher than the thermal resistance retention rate of the thermal insulation filling materials of various comparative examples.

It is thus clear that the thermal insulation filling material of the embodiments of the present invention remains uniform after being washed many times, and does not apparently change in performance. However, the thermal insulation filling materials of various comparative examples intertwine after being washed, and their performances degrade in different degrees. Therefore, the thermal insulation filling material of the embodiments of the present invention has excellent wash durability.

Particularly, although the thermal insulation filling materials of comparative examples 3 and 4 consist of bulk fibres and spherical fibre assemblies and superior to the thermal insulation filling material (purely bulk fibres) of the comparative example 1 in terms of wash durability, they are apparently inferior to the thermal insulation filling material of the embodiments of the present invention. This indicates that with respect to a purely fibrous material, by mixing bulk fibres and spherical fibre assemblies, the wash durability thereof can be improved, on this basis, the wash durability of the thermal insulation filling material can be further improved if the bulk fibres and spherical fibre assemblies are subjected to water repellency treatment.

Water repellency indicates the capability of fabrics not soaked by water, wash durability indicates the capability of fibres keeping properties unchanged (no agglomeration or intertwist) in the process of water washing. It is thus clear that the water repellency and the wash durability have different meanings, and no necessary relation is between both. Particularly, water washing is a process of longer time, thus in the process of water washing, fibres may be soaked by water eventually no matter the water repellency is good or bad. Therefore, according to the general viewpoint, water repellency seemingly has no effect on improving the wash durability. However, in the present invention, it is creatively found that by applying a water-repellent agent to mixed bulk fibres and spherical fibre assemblies, unexpectedly the wash durability thereof is improved, which is non-obvious.

In conclusion, the thermal insulation filling material of the embodiments of the present invention is good in wash durability, and has combination properties such as better blowable processability, quick-drying property, compression-resilience property, and thermal insulation property, etc. Furthermore, by means of the foregoing preparation method, the mixing and the water repellency treatment may be simultaneously conducted, thereby obtaining the thermal insulation filling material having excellent property by means of a simple method.

It is to be understood that the foregoing implementation manners are merely exemplary implementation manners to describe the principle of the present invention. However, the present invention is not limited to this. To those of ordinary skill in the art, various modifications and improvements may be made without departing from the spirit and essence of the present invention, and these modifications and improvements are also deemed to be within the scope of protection of the present invention.

What is claimed is:

1. A thermal insulation filling material, comprising:
a bulk fibre; and
a spherical fibre assembly;
wherein
a water-repellent layer is formed on a surface of the bulk fibre and of the spherical fibre assembly, and
a weight ratio of the bulk fibre to the spherical fibre assembly is between about 30:70 and about 70:30.

2. The thermal insulation filling material of claim 1, wherein
the weight ratio of the bulk fibre to the spherical fibre assembly is between about 40:60 and about 60:40.

3. The thermal insulation filling material of claim 1, wherein
a fibre constituting the bulk fibre has a length between about 15 mm and 75 mm.

4. The thermal insulation filling material of claim 3, wherein
the fibre constituting the bulk fibre has a length between about 28 mm and about 51 mm.

5. The thermal insulation filling material of claim 1, wherein
a fibre constituting the bulk fibre has a fineness between about 0.2 D and about 15 D.

6. The thermal insulation filling material of claim 5, wherein
the fibre constituting the bulk fibre has a fineness between about 0.5 D and about 7 D.

7. The thermal insulation filling material of claim 1, wherein
a fibre constituting the spherical fibre assembly has a length between about 15 mm and 75 mm.

8. The thermal insulation filling material of claim 7, wherein
the fibre constituting the spherical fibre assembly has a length between about 28 mm and about 64 mm.

9. The thermal insulation filling material of claim 1, wherein
a fibre constituting the spherical fibre assembly has a fineness between about 0.7 D and about 15 D.

10. The thermal insulation filling material of claim 9, wherein
the fibre constituting the spherical fibre assembly has a fineness between about 3D and about 7 D.

11. The thermal insulation filling material of claim 1, wherein
the spherical fibre assembly has a particle size between about 3 mm and about 15 mm.

12. The thermal insulation filling material of claim 1, wherein
a fibre constituting the spherical fibre assembly has a three-dimensional crimp hollow structure.

13. The thermal insulation filling material of claim 1, wherein
fibres constituting the bulk fibre and the spherical fibre assembly are silicone fibres.

14. A method for preparing thermal insulation filling material, comprising:
gas-flow mixing a bulk fibre and a spherical fibre assembly to form a mixture, and adding a water-repellent agent in the mixing process, wherein a weight ratio of the bulk fibre to the spherical fibre assembly is between about 30:70 and about 70:30; and
heating to form a water-repellent layer on the surface of the bulk fibre and of the spherical fibre assembly.

15. The method for preparing thermal insulation filling material according to claim 14, wherein
the ratio of the weight of the water-repellent agent to the total weight of the bulk fibre and the spherical fibre assembly is between about 0.5% and about 5%.

16. The method for preparing thermal insulation filling material according to claim 15, wherein
the ratio of the weight of the water-repellent agent to the total weight of the bulk fibre and the spherical fibre assembly is between about 1% and about 2.5%.

17. The method for preparing thermal insulation filling material according to claim 14, wherein
a temperature of the heating is between about 110° C. and about 200° C.; and
time of the heating is between about 2 minutes and about 10 minutes.

18. A thermal insulation product, comprising:
a cladding body, configured to define enclosed internal space; and
thermal insulation filling material filled in enclosed internal space as defined by the cladding body, wherein the thermal insulation filling material comprises: a bulk fibre; and a spherical fibre assembly, wherein a water-repellent layer is formed on a surface of the bulk fibre and of the spherical fibre assembly, and a weight ratio of the bulk fibre to the spherical fibre assembly is between about 30:70 and about 70:30.

19. The thermal insulation product of claim 18, wherein
the cladding body is a flexible cladding body.

20. The thermal insulation product of claim 18, wherein
the thermal insulation product is any one of shoes, a cap, clothes, a pillow, a quilt, a mattress and a sleeping bag.
wherein providing the ESD discharge path includes receiving an ESD event at a drain terminal of the NMOS transistor and discharging the ESD event through the source terminal of the NMOS transistor to ground.
